(19) United States
(12) Patent Application Publication
(10) Pub. No.: US 2009/0293577 A1
(43) Pub. Date: Dec. 3, 2009

(54) JAW SET AND JAW SET SYSTEM WITH HINGED JAW ARMS FOR USE IN A PRESSING TOOL

(75) Inventor: James E. Hamm, Grafton, OH (US)

Correspondence Address: RANKIN, HILL & CLARK LLP, 38210 Glenn Avenue, WILLOUGHBY, OH, 44094-7808, US

(73) Assignee: EMERSON ELECTRIC CO., St. Louis, MO (US)

(21) Appl. No.: 12/128,026

(22) Filed: May 28, 2008

(51) Int. Cl. B25B 27/02

(52) U.S. Cl. 72/416

(57) ABSTRACT

A jaw arm for a compression tool is segmented by a hinge and has a front body portion pivotably connected with a main body portion by the hinge. A jaw recess is formed at one end of the jaw arm in the front body portion. A compression tool comprises a pair of parallel spaced apart side plates, and a pair of the hinged jaw arms pivotally mounted between the plates. The front body portions are pivotable relative to trhe main body portions to enable the compression tool to be used in areas with limited accessibility. In one form, the front body portions of the jaw set are mutually self-aligning. In a further form, the front body portions are pre-positionable relative to their respective main body portions to maintain the jaw arms in adjusted positions for additional ease of use in the areas with limited accessibility. In a still further form, the front body portions of the jaw set are both mutually self-aligning and pre-positionable relative to their respective main body portions. Jaw set systems include a pair of main body portions configured for use with a range of sets of symmetric and asymmetric front body portions for performing various operations such as pressing, crimping, gripping, holding and embossing on a range of workpieces.

### BACKGROUND

The present exemplary embodiments relate to the art of pressing tools for joining pipes, tubes, and couplings using compression type fittings and, more particularly, to improvements in connection with the pivotal jaw arm members for a compression or pressing tool making the tool easier to use in applications where access to the workpiece is limited or difficult. The embodiments find application in conjunction with electro-mechanical power tools for pressing copper and PEX fittings and other workpieces, and will be described with particular reference thereto. The embodiments also find application in conjunction with power and/or manual tools for crimping, cutting, gripping and otherwise working, processing or performing operations on parts or workpieces. It is also to be appreciated that the present exemplary embodiments are also amenable to other similar applications including anywhere a workpiece such as a fitting, member, or part is compressed, gripped, cut, crimped or held between jaws or between jaw arms. The rearward portions of the jaws may take on any shape or configuration and may be actuated by cams and rollers, over-center mechanisms such as in bolt cutters, feed screw mechanisms or any other type of arrangements.

Compression tools for joining tubes or pipes and coupling components are well known as shown, for example, in U.S. Pat. No. 6,035,775 to Nghiem and U.S. Pat. No. 6,434,998 to Amherd. Such tools include a compression jaw set removably mounted on a drive mechanism by which the jaw arms of the set are displaced into compression about a pipe and coupling to join the latter. The jaw set is comprised of a pair of jaw arm members pivotally mounted between a pair of side plates and having inwardly open, opposed jaw recesses at one end and laterally inwardly facing cam surfaces at the opposite ends. The jaw arms are pivotal about pins located in openings through the jaw arms between the opposite ends thereof, and the jaw set is mountable on the drive mechanism by means of the side plates and at a location relative to the jaw set which is laterally between the pivot pins and between the pivot pins and cam surfaces of the jaw members. The drive mechanism includes cam rollers which are displaceable axially forwardly and rearwardly along the cam surfaces of the jaw members and, when displaced forwardly of the cam surfaces, the rollers engage the latter and displace the opposed jaw recesses toward one another and constrictably about a pipe and coupling disposed therebetween.

The jaw recesses are of course contoured to first engage a pipe or tube and coupling and then compress the coupling therebetween so as to sealingly interengage the components. Accordingly, it is important that the jaw recesses be aligned perpendicular to the axes of the pipe and coupling during this process, particularly during the compression operation. Failure to properly align the jaw recesses with the coupling can result in crushed fitting, or improper crimping of the coupling relative to the pipe or copper tube which can lead to leakage when the line being installed is placed in use, such as for delivering liquid under pressure. Alignment is somewhat difficult to achieve under any circumstances in that the operator of the compression tool must support the latter with the jaws open, engage the jaws about a pipe or tube and coupling, and then actuate the drive mechanism to complete the compression process. Therefore, as will be appreciated from the aforementioned patent to Nghiem, the size and weight of the drive mechanism and jaw assembly add to the difficulty in obtaining and maintaining proper alignment between the jaw recesses, pipe or tube and coupling, and the alignment process is made more difficult if the component parts to be compressed are located above the operator's head and/or in areas that are difficult to gain access to.

One effort to overcome the foregoing problem is shown in German Utility Model Application DE 93 14 054 U1 wherein jaw recesses which are integral with the jaw arm members are at a fixed angle of about five (5) to twenty (20) degrees relative thereto. While such a disposition of the recesses does enable an operator to make a crimp close to an object, such as a wall, it remains that the jaw recesses are rigid relative to one another and thus to the pipe and coupling to be crimped, whereby care must be taken by the operator to assure proper alignment between the jaws and the components to be compressed. A high degree of care must be taken by the operator both prior to and during the pressing process because the natural tendency is to align the tool perpendicularly with the target pipe rather than at the fixed small angle as required by the rigid jaws. Movement of the tool relative to the workpiece during pressing could adversely affect its integrity.

U.S. Pat. No. 6,923,037 to Bowles also shows jaws having a fixed angle. In Bowles, the fixed angle is about 45 degrees. Here the jaws press the workpiece indirectly through an intermediary clamp ring. The clamp ring is an additional working member which is not attached to either the pressing tool or the workpiece.

Another approach to resolving the alignment problem in constricted or limited workplaces is shown in U.S. Pat. No. 6,477,757 to Viegener wherein the jaw arms of a jaw set, although straight and without any particular fixed angle, are adapted to receive an auxiliary crimping jaw attachment which is pivotal relative to the jaw arms to achieve alignment between the working faces of the attachment and the pipe and coupling to be crimped when the jaw set is attached to the drive. The attachment comprises a pair of jaw arms pivotally connected to provide a crimping ring assembly in which the jaw arms include jaw recesses which are rigid relative to one another. While this design does provide articulation between the crimping jaws of the attachment and the jaw arms of the jaw set, the design requires two separate assemblies, namely a crimping ring assembly and an actuator jaw assembly. Moreover, use of the device requires mounting of the attachment about a pipe and coupling to be crimped and, then, connection of the attachment with the jaw arms of the jaw set. It will be appreciated, therefore, that the design is expensive to construct and that use thereof is cumbersome and time-consuming and, in many cases, may require two operators to achieve the mounting of the attachment and the connection thereof to the jaw arms of the jaw set.

Still yet another approach is presented in U.S. Pat. No. 7,188,508 to Bowles et al. wherein a jaw arm for a compression tool is provided with a jaw insert which is pivotal relative to the jaw arm to facilitate alignment of the insert with a corresponding portion of a tube and coupling to be crimped through the use of the compression tool. The jaw insert is removably mounted in a recess provided therefor in a jaw arm and is supported in the recess for pivotal displacement relative to the jaw arm about an insert axis extending transverse to the pivot axis of the jaw arm. The insert and jaw arm recess have facially interengaging arcuate surfaces so as to optimize support of the insert during a compression operation. The insert can be manually displaced relative to the jaw arm so as to establish an approximate angular position of the insert relative to the jaw arm prior to initiating a compression operation and a biasing arrangement may be provided between the jaw arm and insert which creates a torque requirement for pivoting the insert and, thus, promotes maintaining the insert in the adjusted position. Such prepositioning is of particular advantage when the location of the joint to be crimped cannot be accessed with the drive mechanism perpendicular to the axes of the pipe and coupling components to be crimped. In any event, even if the location for the compression operation is such that the drive mechanism and thus the jaw arms can be positioned perpendicular to the axes of the pipe and coupling to be joined, the pivotal capability of the insert advantageously provides for the pair of inserts on the arms of a jaw set to be self-aligning relative to the coupling components and to each other as the inserts are moved into place on opposite sides of the coupling components. Therefore, even if the operator does not have the drive mechanism exactly perpendicular to the axes of the coupling components, proper alignment of the inserts is achieved and, accordingly, proper crimping of the coupling components is achieved. This tool has been well-received by skilled craftsmen.

It is desirable, therefore, to provide a tool that realizes all of the advantages of the tools taught in the '037 and '508 patents to Bowles et al. and others as well.

It is further desirable to provide a tool without necessarily the need for the jaw insert of Bowles, but with hinged jaw arms to facilitate alignment of the drive mechanism with a corresponding portion of a pipe or tube and coupling to be crimped. Therefore, even if the operator does not position the drive mechanism exactly perpendicular to the axes of the coupling components, proper alignment of the facially aligned recesses provided on pivotable ends of the jaw arms is achieved and, accordingly, proper crimping of the coupling components is achieved. However, it is to be appreciated that the jaw insert of Bowles might be provided as needed or desired in such a tool with hinged jaw arms to facilitate alignment of the drive mechanism with a corresponding portion of a pipe, tube and coupling to be crimped or other workpiece to be processed using various operations.

It is further desirable to provide a tool system wherein several sets of the hinged jaw arms are interchangeable with main body portions thereof so that the tool system can be used on a variety of sizes of workpieces, on a variety of workpiece styles, formats or types, and in a manner to perform various processing or operations on the workpieces including but not limited to gripping, cutting, crimping, holding, pinching, pressing and compressing.

These and other advantages and benefits are provided by the jaw set with hinged jaw arms described herein.

### BRIEF DESCRIPTION

In accordance with one aspect of the present application, a compression tool is provided including a pair of parallel spaced apart side plates having front ends and defining a gap therebetween, a pair of pivot pins extending transversely between the side plates, and a pair of segmented jaw arms each including a main body portion and a front body portion connected at a hinge region allowing an angle of rotation between respective hinged main and front body portions. The main body portions of the pair of segmented jaw arms are disposed between the pair of side plates in the gap and have pivot pin openings receiving the pivot pins between the side plates for pivotal displacement of the jaw arms about corresponding parallel pivot axes between opened and closed positions. Each jaw arm of the pair of segmented jaw arms has inner and outer edges laterally spaced from and extending forwardly of a first plane connecting the pivot axes. The inner edge of each jaw arm includes a laterally inwardly open jaw recess formed in the front body portion and a substantially planar portion adjacent the laterally inwardly open jaw recess. The jaw arms during use of the compression tool being pivoted about the pivot axes to displace the front body portions laterally toward one another from the opened position to the closed position of the jaw arms for the jaw recesses to compress an object therebetween and for the substantially planar portions to mutually abut in the closed position.

In accordance with an aspect of the substantially planar portions, the planar portions are defined on the main body portions of the pair of segmented jaw arms and mutually abut in the closed position. The gap may be in the range of 0.020 in. to 0.030 in. for example. Also, the gap may have other sizes as necessary or desired.

In accordance with a further aspect of the substantially planar portions, the front body portions of the pair of segmented jaw arms are disposed in a spaced apart relationship by a predefined gap when the substantially planar portions defined on the main body portions of the pair of segmented jaw arms mutually abut in the closed position.

In accordance with a still further aspect of the substantially planar portions, the planar portions are formed on opposite sides of the laterally inwardly open jaw recesses and mutually abut on the opposite sides of the laterally inwardly open jaw recesses in the closed position.

In accordance with an aspect of a further embodiment, the pair of segmented jaw arms of the compression tool includes a first jaw arm and a second jaw arm, the first jaw arm including first main and front body portions connected at a first hinge region allowing a first angle of rotation between the first main and front body portions about a first hinge axis, and the second jaw arm includes second main and front body portions connected at a second hinge region allowing a second angle of rotation between the second main and front body portions about a second hinge axis. The first and second hinge axes are substantially parallel when the pair of segmented jaw arms is in the closed position.

In a further aspect, a first hinge pin couples the first main body portion with the first front body portion, and a second hinge pin couples the second main body portion with the second front body portion. The first and second hinge axes are preferably substantially collinear when the pair of segmented jaw arms is in the closed position.

The first and second angles of rotation are about 90 degrees.

In accordance with an aspect of a further embodiment, the first hinge region includes a first positioning device for holding the first main body portion and the first front body portion in a selected relative position, and the second hinge region includes a second positioning device for holding the second main body portion and the second front body portion in a selected relative position.

In one form, the first and second positioning devices are first and second ball detent devices.

In accordance with an aspect of a further embodiment, an alignment portion is provided for urging the first and second front body portions into relative planar alignment when the pair of segmented jaw arms is moved between the opened and closed positions

In one form, the alignment portion includes a first alignment region on the first front body portion including a one of a V shaped boss and a V shaped groove defined by the inner edge of the first front body portion, and a second alignment region on the second front body portion including the other one of said V shaped boss and said V shaped groove defined by the inner edge of the second front body portion.

In another form, the alignment portion includes a first recess defined by the inner edge of the first front body portion, a second recess defined by the inner edge of the second front body portion, and an elongate resilient member having opposite first and second ends, the first end of the resilient member being slidably received in said first recess and the second end of the resilient member being slidably received in the second recess.

In accordance with an aspect of a further embodiment, a hinged jaw set system is provided. The hinged jaw set system includes a pair of parallel spaced apart side plates a pair of pivot pins extending transversely between the side plates, a pair of segmented jaw arms each including a main body portion, and a plurality of sets of front body portions each being selectively connectable at a hinge region allowing an angle of rotation between respective hinged main and front body portions.

The main body portions of said pair of segmented jaw arms are disposed between the pair of side plates and have pivot pin openings receiving the pivot pins between the side plates for pivotal displacement of the jaw arms about corresponding parallel pivot axes between opened and closed positions. Each jaw arm of the pair of segmented jaw arms has inner and outer edges laterally spaced from and extending forwardly of a first plane T connecting the pivot axes. The jaw arms during use of the jaw set system being pivoted about the pivot axes to displace the front body portions laterally toward one another from the opened position to the closed position of the jaw arms for the front body portions to perform an operation on an associated workpiece therebetween.

In one form of the hinged jaw system, the first set of the front body portions defines a first recess having a first size, the second set of the front body portions defines a second recess having a second size larger than the first size, and a third set of the front body portions defines a third recess having a third size larger than the second size. In this form, the operation performed on the associated workpiece is a pressing operation using a one of the first, second, and third recesses by a selective attachment of a one of the front body portions with the main body portion at the hinge region.

In another form of the hinged jaw system, the first set of the front body portions defines a first recess having a generally flat circular surface configured to receive a round workpiece, the a second set of the front body portions defines an upper gripping jaw and a lower gripping jaw spaced apart by a gap therebetween, and the third set of the front body portions defines a pair of opposed cutting portions having a cutting edge thereon. In this form, the operation performed on the associated workpiece is a one of a pressing operation using the first set of the front body portions, a gripping operation using the second set of the front body portions, and a cutting operation using the third set of the front body portions, by a selective attachment of a one of the front body portions with the main body portion at the hinge region.

These and other aspects of the embodiments of the present jaw set with hinged jaw arms will be described in detail below.

### BRIEF DESCRIPTION OF THE DRAWINGS

The foregoing and other aspects, advantages, and objects will in part be obvious and in part pointed out more fully hereinafter in conjunction with the written description of preferred embodiments of the invention illustrated in the accompanying drawings in which:

FIG. 1 is a plan view of a prior art jaw set including compression jaw arms of the character generally to which the present application is directed;

FIG. 2 is a side elevation view of the jaw set in FIG. 1;

FIG. 3 is a plan view of a jaw arm set having pivotable front body portions for pressing workpieces with a drive mechanism held at oblique angles in accordance with the present application;

FIG. 3a is a plan view of a modified jaw arm set having pivotable front body portions for pressing workpieces and main body portions for mutual abutment in accordance with a further form of the present application;

FIG. 4 is a side elevation view of the jaw set in FIG. 3;

FIG. 5 is a perspective view of the jaw set of FIGS. 3 and 4;

FIG. 6 is a perspective view of a modification to a jaw arm of the jaw set shown in the embodiment of FIGS. 3-5;

FIG. 7 is a plan view of a jaw set using a jaw arm of the type shown in FIG. 6;

FIG. 8 is a cross-sectional view of the jaw set of FIG. 7 taken through line 8-8;

FIG. 9 is a perspective view of a further modification to a jaw arm of the jaw set shown in the embodiment of FIGS. 3-5;

FIG. 10 is a plan view of a jaw set using a jaw arm of the type shown in FIG. 9;

FIG. 11 is a cross-sectional view of the jaw set of FIG. 10 taken through line 11-11;

FIG. 12 is a perspective view of a further modification to a jaw arm of the jaw set shown in the embodiment of FIGS. 3-5;

FIG. 13 is a cross-sectional view of the jaw set of FIG. 12 taken through line 13-13;

FIG. 14 is a plan view of a jaw arm set having pivotable front body portions for pressing workpieces at oblique angles in accordance with a further embodiment of the present application;

FIG. 15 is a plan view of a hinged jaw set system in accordance with a further preferred embodiment for use with a range of workpiece sizes; and,

FIG. 16 is a plan view of a hinged jaw set system in accordance with a still further preferred embodiment for performing various operations on a range of workpieces.

### DETAILED DESCRIPTION OF PREFERRED EMBODIMENTS

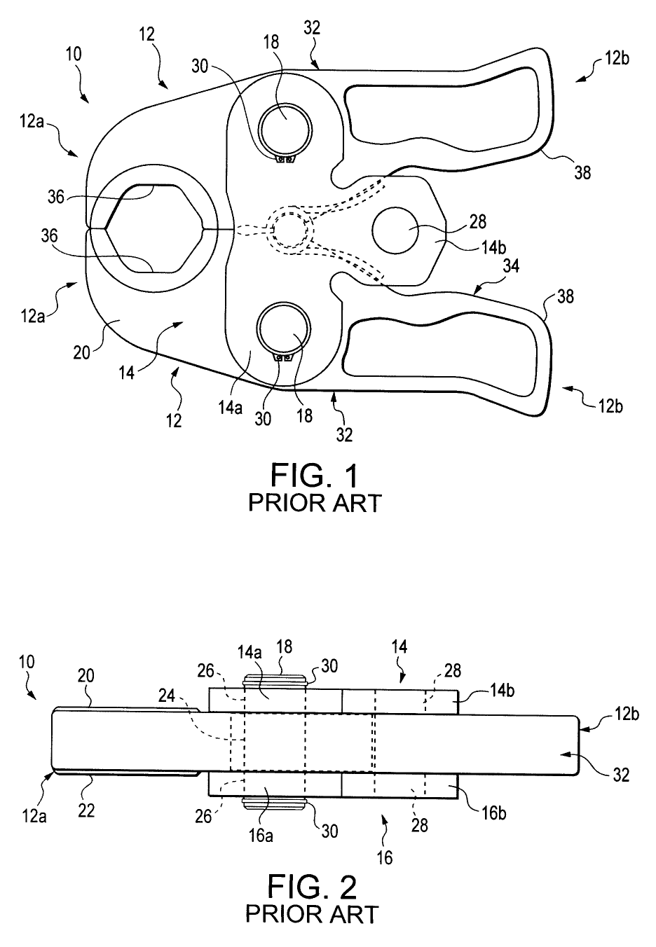

Referring now in greater detail to the drawings, wherein the showings are for the purpose of illustrating preferred embodiments of the invention only and not for the purpose of limiting the invention, FIGS. 1 and 2 illustrate a prior art jaw set 10 comprising a pair of jaw arm members 12 which are mounted, in the orientation shown in FIGS. 1 and 2, between top and bottom side plates 14 and 16, respectively, by a corresponding pivot or bearing pin 18. Each of the jaw arm members has a top side 20, a bottom side 22, and a pin opening 24 therethrough for receiving the corresponding pin 18. Side plates 14 and 16 are generally T-shaped and include laterally opposite sides 14a and 16a, respectively, which are provided with aligned holes 26 for receiving the outer ends of the corresponding pin 18. Side plates 14 and 16 further include rear ends 14b and 16b, respectively, which are provided with aligned openings 28 therethrough which are adapted to receive a mounting pin by which the jaw set is mounted on a drive unit in a well-known manner. The jaw arm members and side plates are retained in assembled relationship by spring clips 30 carried in grooves formed on the opposite ends of each of the pins 18.

Each of the jaw arm members 12 has longitudinally opposite front and rear ends 12a and 12b, respectively, and laterally outer and inner edges 32 and 34, respectively, which are spaced from opening 24 and extend forwardly and rearwardly of the opening. Inner edges 34 of the jaw arm members are provided with laterally inwardly open opposed jaw recesses 36 at front ends 12a and forwardly of the side plate, and laterally inwardly facing cam surfaces 38 at rear ends 12b and rearwardly of rear ends 14b and 16b of the side plates. Inner sides 34, laterally inwardly of pin openings 24, receive and support a coil spring 40 which biases jaw arm members 12 in opposite directions about pins 18 to bias jaw recesses 36 laterally inwardly toward one another. Each of the jaw recesses is integral with the corresponding jaw arm member, and the recesses are contoured to provide working surfaces which cooperatively engage about component parts to be joined by compression.

In use, jaw set 10 is mounted on a drive mechanism in a well-known manner by means of a holding pin which is attached to the drive mechanism and received in side plate openings 28. Ends 12b of the jaw arm members are then manually displaced toward one another to pivot the arm members about pins 18 against the bias of spring 40 to open the jaw recesses 36 to receive a pipe and coupling to be compressed and, upon release of the jaw arm members, spring 40 closes the jaw recesses about the pipe and coupling. The drive unit is then actuated for the cam rollers thereon to advance axially forwardly of the jaw set and simultaneously engage against cam surfaces 38 to displace jaw arm members 12 about pins 18 for jaw recesses 36 to compress the pipe and coupling together. Thereafter, the drive unit is actuated to withdraw the cam rollers, and the jaw arm members are again manually displaced against the bias of spring 40 to open the jaw recesses for removal of the jaw set from the compressed pipe and coupling.

In accordance with the embodiments of the subject jaw arm described herein, the jaw arms of a jaw set which can be similar to the jaw arms and jaw set described above in connection with FIGS. 1 and 2 are modified to provide segmented jaw arms having main and front body portions connected at respective hinge regions forwardly of the side plates to facilitate alignment of the jaw recesses defined in respective front body portions with a corresponding portion of a pipe or tube and coupling to be crimped through use of an associated compression tool. Accordingly, in the following description of preferred embodiments of the invention, the component parts of the jaw arms and jaw set which can correspond to those shown in FIGS. 1 and 2 are designated by like numerals.

In accordance with further embodiments of the subject jaw arm described herein, the jaw arms of a jaw set which can be similar to the jaw arms and jaw set described above in connection with FIGS. 1 and 2 are modified to provide segmented jaw arms having main and front body portions connected at respective hinge regions forwardly of the side plates to facilitate alignment of working areas of the front body portions a corresponding portion of a part or workpiece to be gripped, cut, crimped or held through use of an associated compression tool. Accordingly, in the following description of these preferred embodiments of the invention, the component parts of the jaw arms and jaw set which can correspond to those shown in FIGS. 1 and 2 are designated by like numerals as well.

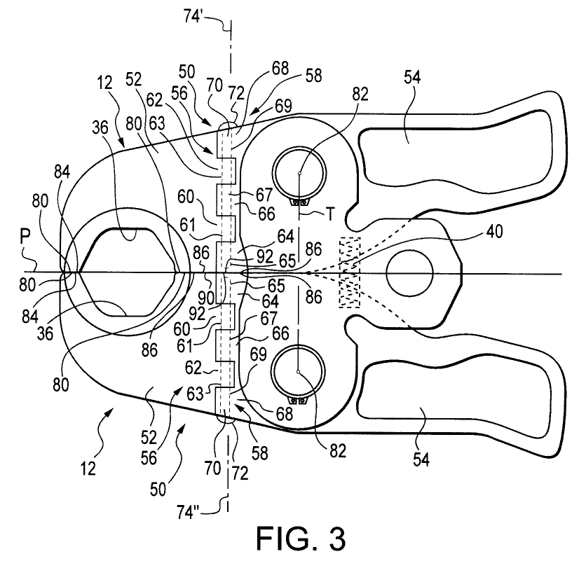

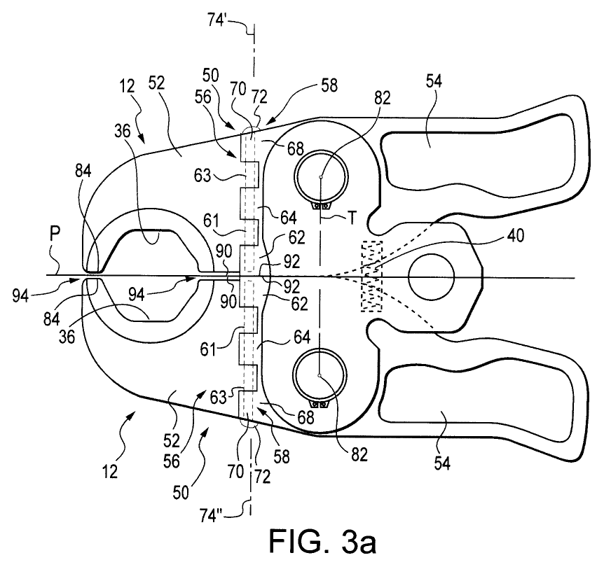

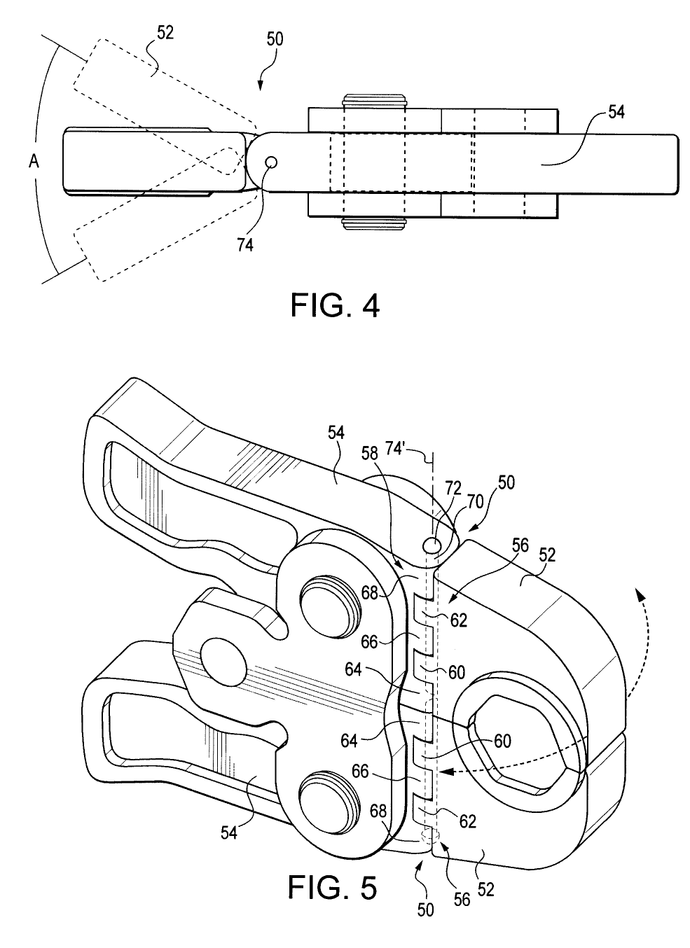

Referring first to FIGS. 3-5 of the drawings, each jaw arm member 12 includes a hinge region 50 so that the jaw arm members are segmented into, generally, two (2) regions including a front body portion 52 forwardly of the hinge region 50 and a main body portion 54 rearwardly thereof. As shown, the jaw recesses 36 are defined by the front body portions 52. As will be described in greater detail below, the hinge region 50 allows an angle of rotation A best illustrated in FIG. 4 between respective hinged front and main body portions permitting the tool 10 to be used with associated drive mechanisms (not shown) held at various selected angles relative to the workpiece. Preferably, the angle of rotation is about 90 degrees. However, it is to be appreciated that the angle of rotation can be smaller and can be as large as 180 degrees if necessary or desired.

In the embodiment shown in FIGS. 3-5, each of the jaw arm members 12 are identically formed and, in that regard, can be used interchangeably in the tool 10 illustrated. Further, preferably, each of the front body portions 52 are identically formed and each of the main body portions 54 are identically formed as well so that the individual segments of the jaw arm members 12 can be replaced separately as necessary or desired. However, the main body portions may be differently formed as necessary or desired and, as well, the front body portions may be differently formed. As an example, the hinge regions may be different in each of the jaw members 12. As further examples, the sizes may be different in each of the jaw members 12 and one or more of the parts may be specially adapted to provide other or additional functions such as for attachment mounting of accessory devices and the like and for other purposes.

The hinge region 50 is preferably provided in the form of a first set of hinge knuckles 56 on an area of the front body portion 52 rearwardly of the jaw recess 36, and a second set of hinge knuckles 58 on an area of the main body portion 54 which is located forwardly of the top and bottom side plates 14,16 when the jaw set 10 is in its assembled configuration as shown in the FIGURES. The jaw arms may be elongated slightly, as may be desired, in the hinge region relative to the embodiment illustrated in the FIGURES, to mechanically accommodate the joint function provided by the hinge region. The first set of knuckles 56 includes, in the preferred embodiment illustrated, a pair of rearwardly directed aligned knuckles 60, 62 (FIG. 3) and the second set of knuckles 58 includes a corresponding set of three (3) forwardly directed aligned knuckles 64, 66, 68 (FIG. 3). Each of the first set of knuckles 60 and 62 is sleeve like, having center openings 61 and 63 (FIG. 3a) which are aligned with the sleeve like center openings 65, 67, 69 (FIG. 3) formed by the forwardly directed second set of knuckles 64, 66, 68.

For each jaw arm member 12, the hinge region 50 is assembled with the rearwardly directed knuckles 60, 62 fitting between adjacent forwardly directed knuckles 64, 66, 68 and a pivot pin 70 inserted laterally through the aligned center openings 61-69. In its preferred form, the pivot pin 70 has an enlarged knurled shoulder area (not shown) adjacent a head portion 72 that frictionally engages the outermost center opening 69 of the set of forwardly directed knuckles and is thereby held in place. The pin is inserted into the center openings 61, 63, 65, 67 and 69 until the head portion 72 prevents further travel to thereby stitch the rearward and forward knuckles 60, 62 of the front and main body portions, respectively, of each jaw arm member together. In this manner, the front and main body portions 52, 54 are pivotally connected together by the pin 70 so as to be rotatable about a hinge pivot axis 74 by the pin 70. Other means can be used to retain the pin 70 relative to the knuckles as well such as threads, additional transverse locking pins, glue, or the like. Rivets and/or retaining clips may be used as well. A fastener such as a screw or the like may be used on one end of the pivot pin 70 to hold it in place.

In the preferred construction illustrated, it is to be observed that the outermost knuckle 68 is carried by the main body portion 54 in a manner by which it engages and overlies a corresponding supporting knuckle 62 carried by the front body portion. This advantageously provides a good and solid bearing surface in an area adjacent the outer edge 32 of the jaw arm which typically experiences large amounts of compressive force during use of the tool 10. The next outermost forwardly directed knuckle 66 is also positioned or arranged so as to engage and overlie a corresponding supporting knuckle 60 to provide an additional bearing surface and support. In their preferred form, the knuckles are flat and smooth at their respective interfaces at planes perpendicular to the hinge axis 74 shown in FIGS. 3 and 3a extending upwardly 74′ and downwardly 74″. However, the flat knuckle interface surfaces may be specially treated such as to be roughened, knurled or serrated, for example, to help hold the jaw arm portions 52, 54 in selected positions during use of the tool 10 against outside forces such as, for example, gravity. Other means to hold the front body portions 52 in place against gravity for example relative to the main body portions 54 may include resilient washers, disks or other devices inserted between the overlapping rearwardly directed 60, 62 and forwardly directed 64, 66, 68 knuckles. These would preferably be held in place by the pivot pin 70 passing through center portions thereof.

In connection with the above description of the preferred embodiment, is to be appreciated that other hinge configurations and arrangements of knuckles and bearing surfaces can be used as well. As examples, two (2), three (3), four (4), five (5) or more knuckle pairs may be used. Knuckles having tapered surfaces, knuckles having interlocking surfaces, single elongate circular bearing surfaces, and resilient members disposed within the knuckle bores may be used and other equivalent structures as well to name a few.

Those skilled in the art appreciate that, during use of the subject jaw set 10, a pipe or tube and coupling to be compressed is first received in the opened jaw recesses 36 which are permitted to close around the workpiece by action of the coil spring 40. The associated power drive unit (not shown) is then activated for the cam rollers thereon to advance axially forwardly of the jaw set and simultaneously engage against the inner cam surfaces 38 to displace jaw arm members 12 about pins 18 for jaw recesses 36 to compress the pipe or tube and coupling together.

In the above regard, preferably, as will be appreciated from FIG. 3, the inner edge 34 of the jaw arm members 12 includes a substantially flat edge 80 defining a plane P which bisects a transverse line T connecting the laterally spaced apart centers 82 of the pivot pins 18. Preferably, the plane P is perpendicular to the transverse line T. The flat edge 80 includes an outer planar surface 84 forwardly of the jaw recess 36 and an inner planar surface 86 rearwardly of the jaw recess. Each of the noted surfaces 84, 86 are flat and co-planar and, particularly, are within the plane P so that opposed planar surfaces on respective jaw arm members mutually substantially abut in the plane P when the tool 10 is in a closed position as shown in FIG. 3. In that way, full and even pressure is applied to the pipe or tube and coupling workpiece and, more importantly, the parting line impression formed by the tool on the coupling is minimized.

As can yet further be seen from the FIGURE, however, the inner planar member 86 essentially spans the hinge region 50 of the jaw arm members 12. More particularly, a first flat surface 90 is defined on the inner edge 34 of the jaw arm member by the front body portion 52 forwardly of the hinge region 50, and a second flat surface 92 is defined on the inner edge 34 of the jaw arm member by the main body portion 54 rearwardly of the hinge region 50. In the embodiment illustrated, all of the opposed flat surfaces 84, 90, 92 mutually substantially abut when the pair of segmented jaw arms are in the closed position as shown in FIG. 3 to promote an even distribution of forces across the flat edges 80 in the jaw arms forwardly of the pin openings 24 when the jaw arms are brought into the closed orientation illustrated.

In a further embodiment shown in FIG. 3a, however, the relationship of the flat surfaces 84, 92 and 90, 92 on opposite sides of the hinge region 50 is advantageously used to control an amount of force transmitted to the front body portion 50 by the associated drive mechanism through the main body portion 54. More particularly and with reference to that FIGURE, each of the surfaces 84, 90 forwardly of the hinge region 50 are shaved slightly or otherwise modified or so formed to have a reduced size to permit the second flat surfaces 92 to substantially abut when the tool 10 is moved to its closed position while leaving a small predefined gap 94 between the surfaces 84, 90 and on opposite sides of the recess 36. In this embodiment, the reactionary force generated by the jaw arms during use of the tool is limited in the front body portions 52 to only the reactionary force generated by the jaw arms during crimping of the associated coupling. Any reactionary force beyond the crimping force, such as is typically used in practice to trigger cam roller reversal in the associated drive unit, is directed exclusively through the main body portions 54. Specifically, reactionary force in excess of the crimping force is directed through the interface between the pair of mutually abutting second or inner flat surfaces 92.

In the embodiment of FIG. 3a, the hinge region is relieved of relatively heavy loading because the flat surfaces 84 and 90 are not brought into substantial mutual abutment when the tool urges the jaw arms to their closed position. A substantial reduction in the amount of material and size needed to effect the hinge region is thereby realized. If this excess material is not used in the construction of the jaw set, the overall weight of the jaw set is reduced making it easier to carry and use and rendering the overall tool less expensive. It is to be understood, however, that the additional material may be permitted to remain in the tool such as, for example, in the hinge region. In that case, the overall usable life of the jaw set could thereby be increased.

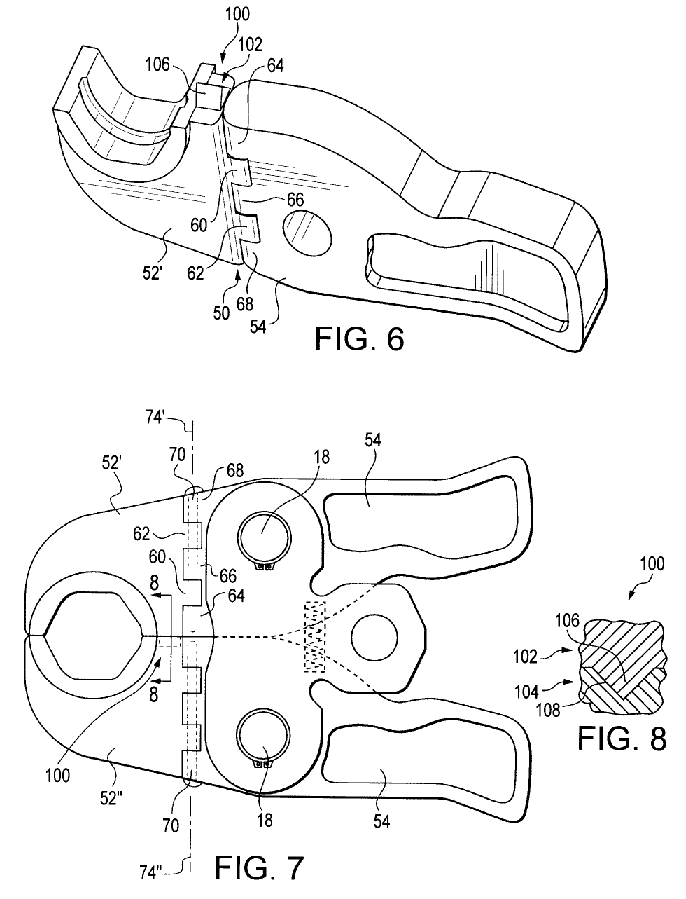

Those skilled in the art will further appreciate that, during use of the subject jaw set 10, ends 12b of the jaw arm members are manually displaced toward one another to pivot the arm members about pins 18 against the bias of the coil spring 40 or other equivalent biasing device to open the jaw recesses 36 to receive a pipe and coupling to be compressed and, upon release of the jaw arm members, spring 40 closes the jaw recesses about the pipe and coupling. During this process, it is desirable to properly align the recesses 36 with the fitting. The subject jaw set permits an angle of rotation A between the front body portions 52 and the main body portions 54 as described above and which greatly enhances the user's ability to properly align the recesses 36 with the fitting permitting the tool to be used in confined areas. However, it is further desirable in many applications and uses to mutually align each of the upper and lower front body portions 52 on opposite sides of the fitting as well. To that end, FIGS. 6-11 show further modifications to the jaw arms which provide an alignment portion 100 thereon for controlling relative movement between the upper and lower front body portions 52′ during use of the tool such as prior to the coupling being received within the recesses 36 of the jaw arm members 12.

Turning first to FIGS. 6-8, the alignment portion 100 comprises complimentary interengaging components 102, 104 which, in this embodiment, are defined by a V-shaped projection 106 on one of the front body portions 52′ and a V-shaped recess 108 in the other of the front body portions 52″. During prepositioning and when the front body portions 52′, 52″ are engaged about a pipe or tube and coupling, the projection 106 and recess 108 interengage to keep the two forward portions of the jaw arm members 12 in approximate relative alignment with one another. The pivotal capability of the jaw arm members 12 relative to each other about pivot pins 18 provides for the front body portions 52 to be self-aligning such that, even when the jaws are in their fully opened orientation, the V-shaped projection 106 on the front body portion 52′ will mechanically interfere with the V-shaped recess 108 in the other of the front body portions 52″ in varying degrees regardless of the relative orientation of the front body portions relative to their respective main body portions. This ensures an approximation of alignment in the fully opened position of the jaw set and more precise and/or controlled alignment as the portions of the jaw arms forward of the pin openings are moved together.

Further, when the pipe or tube and coupling components are in an area which is difficult to access, the user may preset an angle between the front and main body portions of the jaw arms by a pre-positioning means 110 prior to engaging the coupling within the recess. In connection with such pre-positioning of the respective front and main body portions, the torque required to move the front body portions relative to their respective main body portions, as determined by the amount of friction in the hinge area 50 such as between the pin 70 and the knuckles 60-68, advantageously holds the front body portions in selected preset positions as the components are engaged about the workpieces. Other pre-positioning means and devices may be used as well and further embodiments thereof will be described below.

It is to be appreciated that in one embodiment the subject jaw set 10 may be provided with an alignment portion 100 such as, for example, the alignment portion described above, and without a pre-positioning device or means. In this tool, the front body portions are not held in place relative to the main body portions prior to receiving the fitting in the recesses 36 but, rather, are drawn into relative alignment by the alignment portion as the front body portions are brought together. In another embodiment, the subject jaw set 10 may be provided with a pre-positioning device 110 and without an alignment portion 100. In this tool, the front body portions are moved into relative position by hand for example and are held in place prior to receiving the fitting in the recesses by the pre-positioning device, such as by friction, serrated surfaces, or ball detent devices (to be described below) for example. In a further embodiment the tool is provided with both an alignment portion 100 and a pre-positioning device or means. Lastly, in a still further embodiment the tool is functional and very useful without either an alignment portion 100 or a pre-positioning device 110.

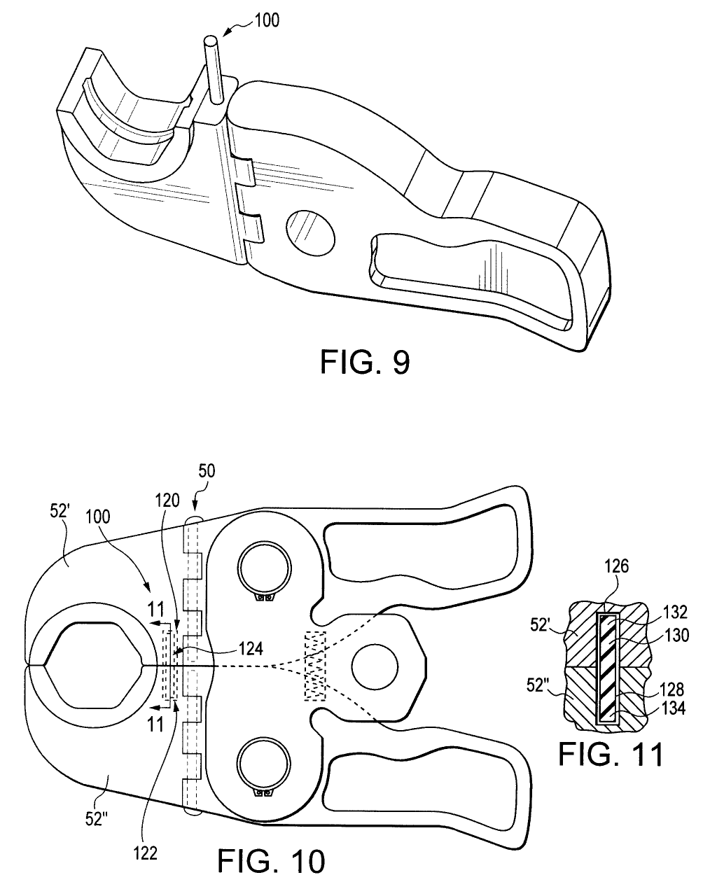

Turning next to FIGS. 9-11, the alignment portion 100 comprises complimentary interengaging components 120, 122, 124 which, in this embodiment, are defined by a first pocket 126 defined in the inner edge 34 of one of the front body portions 52′, a second pocket 128 defined in the inner edge of the other of the front body portions 52″, and an elongate resilient member 130 having opposite first 132 and second 134 ends received in the first and second 126, 128 pockets, respectively. In its preferred form, the resilient member is a cylindrically shaped urethane material. However, other materials may be used as well, such as rubber, nylon, plastic or steel (loosely held) for example. During prepositioning and when the front body portions 52′, 52″ are engaged about a pipe and coupling, the elongate member remains held between the jaw arms by the ends 132, 134 thereof being slidably received in the first and second 126, 128 pockets, respectively. In this embodiment, the pivotal capability of the jaw arm members 12 relative to each other about pivot pins 18 provides for the front body portions 52 to be self-aligning such that, even when the jaws are in their fully opened orientation, neither of the ends 132, 134 of the resilient member 130 are retracted from their respective first and second 126, 128 pockets. This ensures a close approximation of alignment between the opposed front body portion 52′ and 52″ in the fully opened position of the jaw set and movement towards full as the portions of the jaw arms forward of the pin openings are moved together.

Further, again, the torque required to move the front body portions relative to their respective main body portions, as determined by the amount of friction in the hinge area 50 such as between the pin 70 and the knuckles 60-68, advantageously holds the front body portions in selected preset positions as the components are engaged about the workpieces.

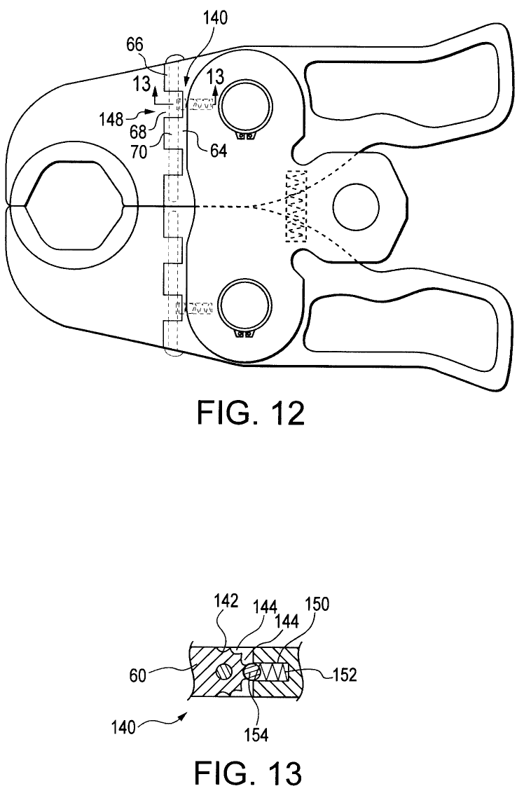

Other pre-positioning means 110 are shown in the embodiment of FIGS. 12 and 13 wherein a ball detent positioning device 140 is provided. At least one of the rearward knuckles 60 defines an arcuate outer surface 142 including a plurality of spaced apart slots 144, preferably in the form of ball detent grooves 146. A crease 148 between the forward knuckles 64, 66 on opposite sides of the rearward knuckle 60 includes a cylindrical counterbore 150 sized to receive a biasing spring 152 and a ball detent 154 therein. The spring and ball are held in place using any suitable means such as, for example, peaning the counterbore, a small lock ring, or by the assembly of the rearward knuckle held in place by the pin 70 extending through the center openings. Due to the cooperative action between the biased ball detent 154 and the detent grooves 146, the angle between the front body portion 52 may be adjusted and fixed relative to the main body portion 54 in a desired articulated or angled position.

Although the embodiments of the present invention have been described in connection with the jaw arms of a jaw set which can be similar to the jaw arms and jaw set shown FIGS. 1 and 2, it is to be appreciated that the embodiments are applicable to other types of jaw arms and jaw sets as well. In that regard, other forms of jaw arms and jaw sets may be modified in ways described herein and in equivalent ways to provide segmented jaw arms having main and front body portions connected at respective hinge regions forwardly of pivot axes of the jaw arms to facilitate alignment of the jaw recesses defined in respective front body portions with a corresponding portion of a tube and coupling to be crimped through use of an associated compression tool. For ease of discussion, however, in the following description of a further preferred embodiment, the component parts of the jaw arms and jaw set which can correspond to those shown in FIGS. 1 and 2 are designated by like numerals.

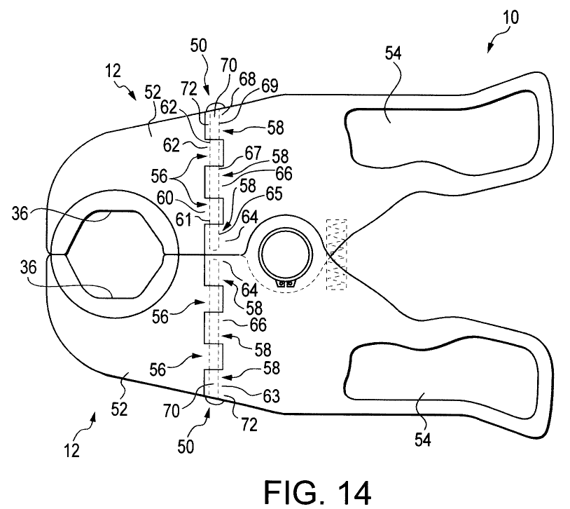

Referring next to FIG. 14 of the drawings, each jaw arm member 12 includes a hinge region 50 so that the jaw arm members are segmented into, generally, two (2) regions including a front body portion 52 forwardly of the hinge region 50 and a main body portion 54 rearwardly thereof. As shown, the jaw recesses 36 are defined by the front body portions 52. As will be described in greater detail below, the hinge region allows an angle of rotation A between respective hinged front and main body portions permitting the tool 10 to be used with associated drive mechanisms (not shown) held at various selected angles relative to the workpiece. Preferably, the angle of rotation is about 90 degrees.

Like the embodiment shown in FIGS. 3-5, each of the jaw arm members 12 of the embodiment of FIG. 14 are identically formed and, in that regard, can be used interchangeably. However, it is to be appreciated that each of the front body portions need not be identically formed. That is, each of the front body portions 52 may be formed differently and, possibly, may be so formed differently to perform different functions during use of the jaw set. Similarly, it is to be further appreciated that each of the main body portions 54 may not be identically formed and may perform different functions as well.

The hinge region 50 is preferably provided in the form of a first set of hinge knuckles 56 on an area of the front body portion rearwardly of the jaw recess 36 and a second set of hinge knuckles 58 on an area of the main body portion 54 which is located forwardly of pivot pin 18 when the jaw set 10 is in its assembled configuration as shown in the FIGURE. The jaw arms may be elongated slightly, as may be desired, in the hinge region to mechanically accommodate the joint function provided by the hinge region. The first set of knuckles 56 includes, in the preferred embodiment illustrated, a pair of rearwardly directed aligned knuckles 60, 62 and the second set of knuckles 58 includes a set of three (3) forwardly directed aligned knuckles 64, 66, 68. Each of the first set of knuckles 60 and 62 is sleeve like, having center openings 61 and 63 which are aligned with the sleeve like center openings 65, 67, 69 formed by the forwardly directed second set of knuckles 64, 66, 68.

The hinge region 50 is assembled with the rearwardly directed knuckles 60, 62 fitting between adjacent forwardly directed knuckles 64, 66, 68 and a pivot pin 70 inserted laterally through the aligned center openings 61-69. In its preferred form, the pivot pin 70 has an enlarged knurled head portion 72 that frictionally engages the outermost center opening 69 of the set of forwardly directed knuckles and is thereby held in place. In this manner, the front and main body portions 52, 54 are pivotally connected together by the pin 70 so as to be rotatable about a hinge pivot axis 74 by the pin 70. Other means can be used to retain the pin 70 relative to the knuckles as well such as threads, additional transverse locking pins, glue, or the like.

Further, in the embodiment of FIG. 14, other structure may be provided as well including an alignment portion (not shown) for providing alignment or timing between opposite front body portions in accordance with any of the embodiments described above, and/or a pre-positioning device or means (not shown) for holding the forward jaw portions in selected positions relative to the main body portions prior to engaging the workpiece with the tool in accordance with any of the embodiments described above.

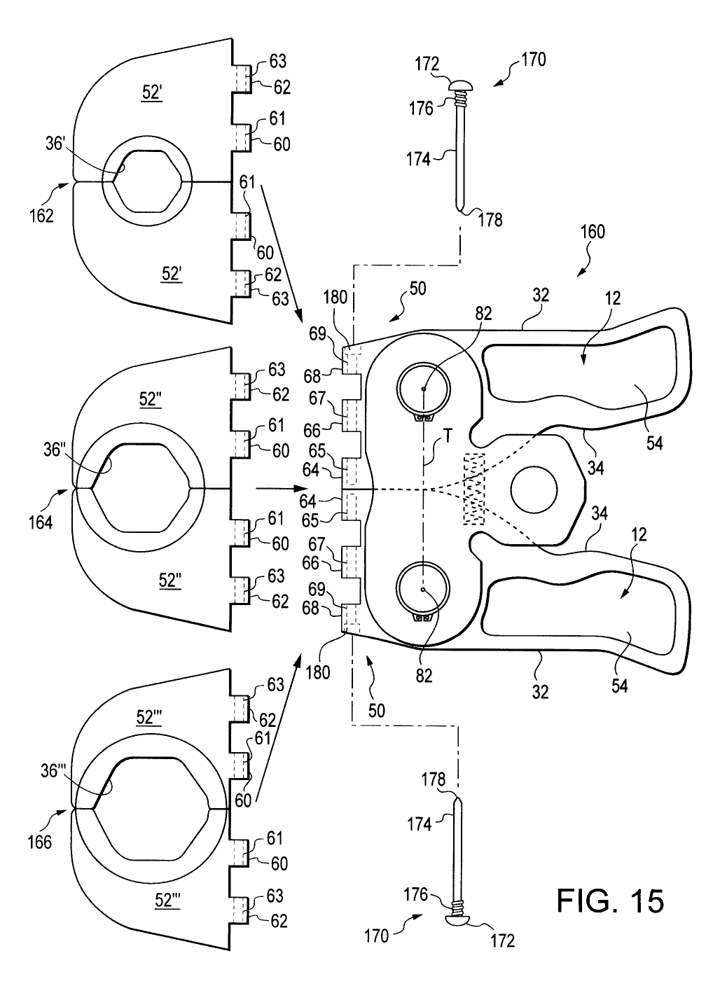

With reference next to FIG. 15, a further embodiment of the present invention includes a hinged jaw set system 160 with hinged jaw arms 12 adapted for selective assembly for accommodating workpieces of various sizes or ranges. In that regard, the jaw set system 160 shown in the FIGURE includes a pair of main body portions 54, each being provided with a hinge region 50 generally of the type described herein. The hinge region 50 is configured to pivotably receive a plurality of sets of front body portions. As illustrated, three (3) sets 162, 164, 166 of front body portions 52′, 52″ and 52′″ are provided wherein each set 162, 164 and 166 has a differently sized jaw recess formed therein. More particularly, the first set 162 of front body portions 52′ defines a small jaw recess 36′ configured to receive and press a ½ inch workpiece such as for example a ½ inch ProPress™ coupling. Further, the second set 164 of front body portions 52′″ defines a medium jaw recess 36″ configured to receive and press a ¾ inch workpiece such as for example a ¾ inch ProPress™ coupling. Still further, the third set 166 of front body portions 52′″ defines a large jaw recess 36′″ configured to receive and press a 1 inch workpiece such as for example a 1 inch ProPress™ coupling.

The front body portions 52′, 52″ and 52′″ are selectively assembled onto and carried by the main body portions 54 using a pivot pin 170 having an outer enlarged head 172, an elongate inner cylindrical bearing surface 174, and a threaded portion 176. Preferably, the cylindrical bearing surface 174 has a chamfered lead end 178 so that the pivot pin 170 may be easily inserted into the set of center openings 61, 63, 65, 67 and 69 formed in the respective rearwardly 60, 62 and forwardly 64, 66, 68 extending knuckles when the jaw arm portions 52, 54 are brought into the correct mutual alignment. In the embodiment illustrated, each of the main body portions 54 includes an internally threaded region 180 adapted to threadedly receive the threaded portion 176 of the pivot pin 170. In that regard, the outer enlarged head 172 of the pivot pin 170 may define a hex head, a slotted screw head or may have the form of a socket head cap screw or the like.

In any case, in this preferred embodiment, an operator can easily and quickly reconfigure the jaw set system 160 for use with different workpieces by simply removing the pivot pins 170, replacing the attached set of front body portions 52 with a desired other set of front body portions and then reinserting and attaching the pivot pins 170 to the main body portions 54. This tool changeover can be performed using ordinary tools.

As understood by those skilled in the art, the jaw recesses 36 can be easily modified from the form or format illustrated and may be provided in additional front body portions (not shown) so that the jaw set system 160 can be used with other sizes of couplings and with other coupling types and styles and with other systems now know or hereinafter developed and others.

Further, in the embodiment of FIG. 15, other structure may be provided as well including an alignment portion (not shown) for providing alignment or timing between opposite front body portions in accordance with any of the embodiments described above, and/or a pre-positioning device or means (not shown) for holding the forward jaw portions in selected positions relative to the main body portions prior to engaging the workpiece with the tool in accordance with any of the embodiments described above.

Although the embodiments of the present invention have been described in connection with the jaw arms of a compression jaw set which can be similar to the jaw arms and jaw set of the compression tool shown FIGS. 1 and 2 used primarily for pressing workpieces, it is to be appreciated that the embodiments are applicable to other types of jaw arms and jaw sets as well such as those used for gripping, cutting, crimping, embossing and holding for example. In that regard, other forms of jaw arms and jaw sets may be modified in ways described herein and in equivalent ways to provide segmented jaw arms having main and front body portions connected at respective hinge regions forwardly of pivot axes of the jaw arms to facilitate alignment of the jaw recesses defined in respective front body portions with a corresponding portion of a workpiece to be gripped, cut, crimped or held.

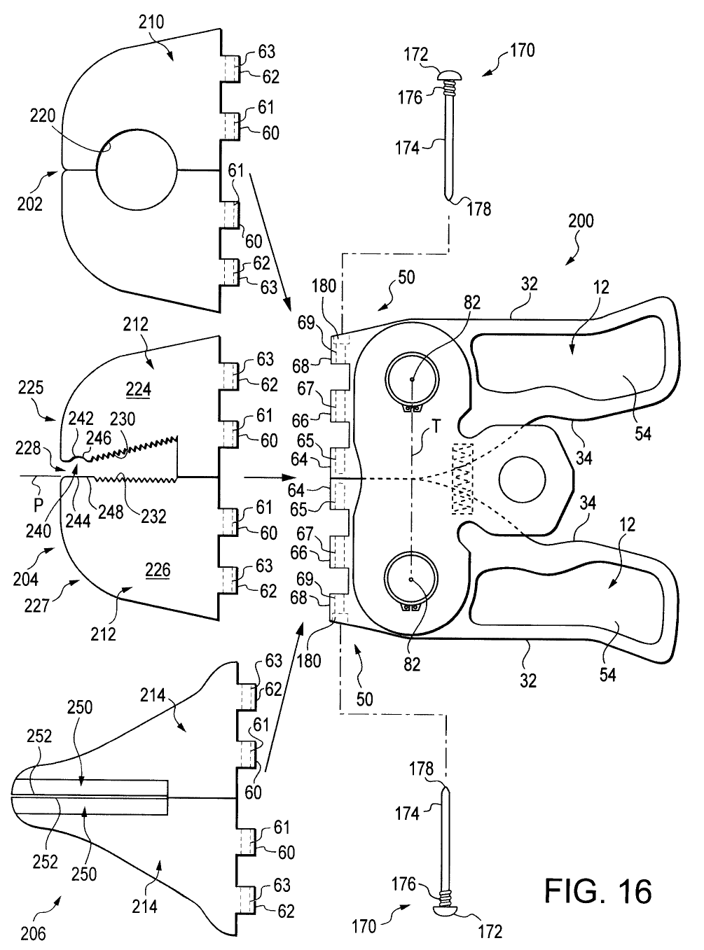

In the above regard and with reference next to FIG. 16, a further embodiment of the present invention includes a hinged jaw set system 200 with hinged jaw arms 12 adapted for selective assembly for performing various types of work on associated workpieces of various sizes or ranges. In that regard, the jaw set system 200 shown in the FIGURE includes a pair of main body portions 54, each being provided with a hinge region 50 generally of the type described herein. The hinge region 50 is configured to pivotably receive a plurality of sets of front body portions. In the Figure, the hinge region 50 is configured to pivotably receive three (3) sets 202, 204, 206 of front body portions 210, 212 and 214 wherein each set 202, 204 and 206 is configured to perform different functions on the associated workpieces. In that regard, as can be seen, each of the front body portions 210,212 and 214 has a different overall construction so as to be able to perform the various functions such as pressing, crimping, gripping, holding, embossing and cutting. More particularly, the first set 202 of front body portions 210 defines a small jaw recess 220 having a generally flat circular surface configured to receive and press a ½ inch workpiece such as for example a ½ inch PEX coupling. Obviously, the jaw recess 220 can be modified to accommodate other sizes of PEX workpieces or other sizes or types of workpieces such as, for example, in the manner described above in connection with the embodiments of FIG. 15 and others. In this embodiment, each of the front body portions 210 is identically formed. However, they may be differently formed to have different structures.

With continued reference to FIG. 16, the second set 204 of front body portions 212 defines an upper gripping jaw 224 and a lower gripping jaw 226 spaced apart at respective outer end regions thereof 225, 227 by a gap 228. Each of the gripping jaws 224, 226 is preferably provided with a row of teeth 230, 232 in a rearward portion of the set of jaws 204 so that a workpiece may be securely held in the portion of the gap between the jaws there during use of the jaw set system 200 in a workpiece gripping mode of operation. In this embodiment, the front body portions 212 are not identically formed. More particularly, the rearward portion of the upper gripping jaw 224 closest to the hinge region 50 is inclined at a first preferred angle relative to the plane P at the parting line between the upper 224 and lower 266 jaws, and the rearward portion of the lower gripping jaw 226 near the hinge region 50 is inclined at a second angle different from the first angle. In the embodiment illustrated, the first angle is about 25° and the second angle is about 0°, although the angles may be selected as necessary or desired or based on intended application of the tool. The teeth may be arranged to define curved profiles or combinations of curved and flat profiles. The outer end regions 225, 227 of the second set 204 of jaw ends in FIG. 16 form a crimping area 240 between opposite surfaces 242, 244 of the upper and lower jaws 224, 226, respectively. In the subject embodiment, the upper surface 242 includes an inwardly directed arcuate surface 246 and the lower surface 244 includes a flat surface 248. The arcuate surface 246 and the flat surface 248 cooperate during use of the jaw set system 200 to crimp workpieces such as, for example, an electrical spade connector or lug in the crimping area 240. Other contours and shapes may be provided on the outer end regions 225, 227 of the jaws 224, 226 to effect other forms of crimping operations or other operations such as embossing on a wide range of workpieces. It is to be appreciated that other shapes and configurations of the upper and lower gripping jaws can be used as desired or as needed based on the requirements of the application.

With still further reference to FIG. 16, the third set 206 of front body portions 214 defines a pair of opposed cutting portions 250 having a cutting edge 252 thereon. The front body portions 214 are generally tapered as shown to save weight and to enable the cutting portions 250 to be used in tight applications. The third set 206 is useful to cut workpieces. In addition, however, it is to be appreciated that one or both of the cutting edges 252 may be replaced with a specialized crimping, pressing or embossing surfaces to crimp, for example, wire harnesses or any of a wide variety of associated workpieces or parts or to press or emboss other parts or workpieces.

Similar to the system described above in connection with FIG. 15, the front body portions 210, 212 and 214 are selectively assembled onto and carried by the main body portions 54 using a pivot pin 170 having an outer enlarged head 172, an elongate inner cylindrical bearing surface 174, and a threaded portion 176. Preferably, the cylindrical bearing surface 174 has a chamfered lead end 178 so that the pivot pin 170 may be easily inserted into the set of center openings 61, 63, 65, 67 and 69 formed in the respective rearwardly 60, 62 and forwardly 64, 66, 68 extending knuckles when the jaw arm portions 52, 54 are brought into the correct mutual alignment. In the embodiment illustrated, each of the main body portions 54 includes an internally threaded region 180 adapted to threadedly receive the threaded portion 176 of the pivot pin 170. In that regard, the outer enlarged head 172 of the pivot pin 170 may define a hex head, a slotted screw head, or may have the form of a socket head cap screw or the like.

In any case, in this preferred embodiment, an operator can easily and quickly reconfigure the jaw set system 200 for use with different workpieces by simply removing the pivot pins 170, replacing the attached set of front body portions 52 with a desired set of front body portions and then reinserting and attaching the pivot pins 170 to the main body portions 54. This tool changeover can be performed using ordinary tools.

Further, in the embodiment of FIG. 16, other structure may be provided as well including an alignment portion (not shown) for providing alignment or timing between opposite front body portions in accordance with any of the embodiments described above, and/or a pre-positioning device or means (not shown) for holding the forward jaw portions in selected positions relative to the main body portions prior to engaging the workpiece with the tool in accordance with any of the embodiments described above.

While considerable emphasis has been placed herein on the structures of and the structural interrelationships between the component parts of preferred embodiments of the invention, it will be appreciated that other embodiments can be devised and that many changes can be made in the embodiments disclosed herein without departing from the principles of the present invention. In particular in this respect, jaw arms as used herein and in the appended claims are intended to include one of a pair of jaw arms in a jaw set of the character shown, for example, in the aforementioned patent to Amherd, one of a pair of jaw arms in a crimping ring of the character shown, for example, in the aforementioned patent to Viegener, and one of a pair of jaw arms with pivotable inserts carried in recesses of the character shown, for example, in the aforementioned patent to Bowles et al. Further, it will be appreciated that either of the arrangements disclosed for controlling relative pivotal displacement of the front body portions relative to the main body portions of the jaw arms can be used with any of the mounting arrangements illustrated and described, as well as other mounting arrangements which can be devised and, similarly, that the arrangements for providing a required torque for pre-positioning the front body portions relative to the main body portions of the corresponding jaw arm may take on any form such as frictional, toothed or any form of engagement of parts. Portions of the jaw arms may take on any shape or configuration and, in particular, portions of the jaw arms rearward of the pivot pins may have any shape or configuration and may be cam-shaped and actuated by rollers as illustrated or may have other structures such as over-center mechanisms for bolt cutters for example, feed screw mechanisms, or any others now known or hereinafter developed. These and other modifications of the disclosed embodiments as well as other embodiments of the invention will be obvious and suggested to those skilled in the art upon reading the foregoing disclosure. Accordingly, it is to be distinctly understood that the descriptive matter herein is to be interpreted merely as illustrative of the invention and not as a limitation and that it is intended to include other embodiments and all modifications of the preferred embodiments insofar as they come within the scope of the appended claims or the equivalents thereof.

Having thus described the preferred embodiments, it is now claimed:

1. A compression tool (10) comprising:
a pair of parallel spaced apart side plates (14, 16);
a pair of pivot pins (18) extending transversely between the side plates (14, 16); and,
a pair of segmented jaw arms (12) each including a main body portion (54) and a front body portion (52) connected at a hinge region (50) allowing an angle of rotation A between respective hinged main (54) and front (52) body portions, the main body portions of said pair of segmented jaw arms being disposed between said pair of side plates (14, 16) and having pivot pin openings (24) receiving said pivot pins (18) between said side plates (14, 16) for pivotal displacement of the jaw arms (12) about corresponding parallel pivot axes (82) between opened and closed positions, each jaw arm (12) of said pair of segmented jaw arms having inner (34) and outer (32) edges laterally spaced from and extending forwardly of a first plane T connecting the pivot axes, the inner edge (34) of each jaw arm (12) including a laterally inwardly open jaw recess (36) formed in the front body portion (52) and a substantially planar portion (80) adjacent the laterally inwardly open jaw recess, the jaw arms (12) during use of the compression tool being pivoted about the pivot axes (82) to displace said front body portions (52) laterally toward one another from said opened position to said closed position of the jaw arms (12) for the jaw recesses (36) to compress an object therebetween and for the substantially planar portions (80) to mutually abut in said closed position.

2. The compression tool according to claim 1 wherein:
the substantially planar portions (80) are defined on the main body portions of said pair of segmented jaw arms and mutually abut in said closed position.

3. The compression tool according to claim 2 wherein:
the front body portions (52) of said pair of segmented jaw arms are disposed in a spaced apart relationship by a predefined gap (94) when the substantially planar portions (92) defined on the main body portions (54) of said pair of segmented jaw arms (12) mutually abut in said closed position.

4. The compression tool according to claim 1 wherein:
the substantially planar portions (84, 86) are formed on opposite sides of the laterally inwardly open jaw recesses (36) and mutually abut on said opposite sides of the laterally inwardly open jaw recesses (36) in said closed position.

5. The compression tool according to claim 1 wherein:
said pair of segmented jaw arms (12) includes a first jaw arm (12′) and a second jaw arm (12″);
the first jaw arm includes first main (54′) and front (52′) body portions connected at a first hinge region (50′) allowing a first angle of rotation A between the first main and front body portions about a first hinge axis (74′); and,
the second jaw arm includes second main (54″) and front (52″) body portions connected at a second hinge (50″) region allowing a second angle of rotation between the second main and front body portions about a second hinge axis (74″), the first and second hinge axes (74′, 74″) being substantially parallel when the pair of segmented jaw arms is in said closed position.

6. The compression tool according to claim 5 further including:
a first hinge pin (70′) in said first hinge region and coupling the first main body portion with the first front body portion; and,
a second hinge pin (70″) in said second hinge region and coupling the second main body portion with the second front body portion

7. The compression tool according to claim 5 wherein the first and second hinge axes (70′, 70″) are substantially collinear when the pair of segmented jaw arms is in said closed position.

8. The compression tool according to claim 7 wherein said first and second angles of rotation are about 90 degrees.

9. The compression tool according to claim 1 further including a positioning portion (110) for holding the first and second front body portions in selected positions relative to the first and second main body portions.

10. The compression tool according to claim 9 further including an alignment portion (100) for urging the first and second front body portions into relative planar alignment when the pair of segmented jaw arms are moved between said opened and closed positions.

11. The compression tool according to claim 9 wherein:
said pair of segmented jaw arms (12) includes a first jaw arm (12′) and a second jaw arm (12″);
the first jaw arm includes first main (54′) and front (52′) body portions connected at a first hinge region (50′) allowing a first angle of rotation A between the first main and front body portions about a first hinge axis (74′);
the second jaw arm includes second main (54″) and front (52″) body portions connected at a second hinge region (50″) allowing a second angle of rotation between the second main and front body portions about a second hinge axis (74″), the first and second hinge axes (74′, 74″) being substantially parallel when the pair of segmented jaw arms is in said closed position.
said first hinge region includes a first positioning device (110′) for holding the first main body portion and the first front body portion in a first selected relative position; and,
said second hinge region includes a second positioning device (110″) for holding the second main body portion and the second front body portion in a second selected relative position.

12. The compression tool according to claim 11 wherein the first and second positioning devices are at least one of: i) first and second ball detent devices (140); ii) first and second friction interfaces; and, (iii) first and second serrated planar interfaces.

13. The compression tool according to claim 1 further including an alignment portion (100) for urging the first and second front body portions into relative planar alignment when the pair of segmented jaw arms are moved between said opened and closed positions

14. The compression tool according to claim 13 further including a positioning portion (110) for holding the first and second front body portions in selected positions relative to the first and second main body portions.

15. The compression tool according to claim 13 wherein the alignment portion (100) includes:
a first alignment region (102) on the first front body portion including a one of a V shaped boss (106) and a V shaped groove (108) defined by the inner edge of the first front body portion; and,
a second alignment region (104) on the second front body portion including the other one of said V shaped boss (106) and said V shaped groove (108) defined by the inner edge of the second front body portion.

16. The compression tool according to claim 13 wherein the alignment portion includes:
a first recess (126) defined by the inner edge of the first front body portion;
a second recess (128) defined by the inner edge of the second front body portion; and,
an elongate resilient member (130) having opposite first (132) and second (134) ends, the first end of the resilient member being slidably received in said first recess and the second end of the resilient member being slidably received in the second recess.

17. A compression tool (10) comprising:
a pivot pin (18);
a first segmented jaw arm (12′) including a first main body portion and a first front body portion, the first main body and front body portions being connected at a first hinge region (50′) allowing an angle of rotation between the respective hinged first main and front body portions, the first segmented jaw arm receiving said pivot pin (18) through a first pivot pin opening (24′) defined through the first main body portion for pivotal displacement of the first segmented jaw arm about a pressing pivot axis between opened and closed positions; and,
a second segmented jaw arm (12″) including a second main body portion and a second front body portion, the second main body and front body portions being connected at a second hinge region (50″) allowing an angle of rotation between the respective hinged second main and front body portions, the second segmented jaw arm receiving said pivot pin (18) through a second pivot pin opening (24″) defined through the second main body portion for pivotal displacement of the second segmented jaw arm about said pressing pivot axis between said opened and closed positions, each jaw arm having inner and outer edges laterally spaced from and extending forwardly of a first plane including said pivot axis, the inner edge of each jaw arm including a laterally inwardly open jaw recess (36) formed in the front body portion and a substantially planar portion adjacent the laterally inwardly open jaw recess, the jaw arms during use of the compression tool being pivoted about said pivot axis to displace said front body portions laterally toward one another from said opened position to said closed position of the jaw arms for the jaw recesses to compress an object therebetween and for the substantially planar portions to mutually abut in said closed position.

18. The compression tool according to claim 17 wherein:
the substantially planar portions (80) are defined on the main body portions of said pair of segmented jaw arms and mutually abut in said closed position.

19. The compression tool according to claim 18 wherein:
the front body portions (52) of said pair of segmented jaw arms are disposed in a spaced apart relationship by a predefined gap (94) when the substantially planar portions (92) defined on the main body portions (54) of said pair of segmented jaw arms mutually abut in said closed position.

20. The compression tool according to claim 17 wherein:
the substantially planar portions (84, 86) are formed on opposite sides of the laterally inwardly open jaw recesses (36) and mutually abut on said opposite sides of the laterally inwardly open jaw recesses (36) in said closed position.

21. The compression tool according to claim 17 wherein:
said pair of segmented jaw arms includes a first jaw arm (12′) and a second jaw arm (12″);
the first jaw arm includes first main and front body portions connected at a first hinge region (50′) allowing a first angle of rotation between the first main and front body portions about a first hinge axis; and,
the second jaw arm includes second main and front body portions connected at a second hinge region (50″) allowing a second angle of rotation between the second main and front body portions about a second hinge axis, the first and second hinge axes being substantially parallel when the pair of segmented jaw arms is in said closed position.

22. The compression tool according to claim 21 further including:
a first hinge pin (70′) coupling the first main body portion with the first front body portion; and, a second hinge pin (70″) coupling the second main body portion with the second front body portion

23. The compression tool according to claim 21 wherein the first and second hinge axes (74′, 74″) are substantially collinear when the pair of segmented jaw arms is in said closed position.

24. The compression tool according to claim 23 wherein said first and second angles of rotation are about 90 degrees.

25. The compression tool according to claim 17 further including a positioning portion (110) for holding the first and second front body portions in selected positions relative to the first and second main body portions.

26. The compression tool according to claim 25 further including an alignment portion (110) for urging the first and second front body portions into relative planar alignment when the pair of segmented jaw arms are moved between said opened and closed positions.

27. The compression tool according to claim 25 wherein:
said first hinge region includes a first positioning device for holding the first main body portion and the first front body portion in a selected relative position; and,
said second hinge region includes a second positioning device for holding the second main body portion and the second front body portion in a selected relative position.

28. The compression tool according to claim 27 wherein the first and second positioning devices are at least one of: i) first and second ball detent devices; ii) first and second friction interfaces; and, iii) first and second serrated planar interfaces.

29. The compression tool according to claim 17 further including an alignment portion (100) for urging the first and second front body portions into relative planar alignment when the pair of segmented jaw arms are moved between said opened and closed positions.

30. The compression tool according to claim 29 further including a positioning portion (110) for holding the first and second front body portions in selected positions relative to the first and second main body portions.

31. The compression tool according to claim 29 wherein the alignment portion includes:
a first alignment region on the first front body portion including a one of a V shaped boss (106) and a V shaped groove (108) defined by the inner edge of the first front body portion; and,
a second alignment region on the second front body portion including the other one of said V shaped boss (106) and said V shaped groove (108) defined by the inner edge of the second front body portion.

32. The compression tool according to claim 29 wherein the alignment portion includes:
a first recess (126) defined by the inner edge of the first front body portion;
a second recess (128) defined by the inner edge of the second front body portion; and,
an elongate resilient member (130) having opposite first (132) and second (134) ends, the first end of the resilient member being slidably received in said first recess and the second end of the resilient member being slidably received in the second recess.

33. A hinged jaw set system (160, 200) comprising:
a pair of parallel spaced apart side plates (14, 16);
a pair of pivot pins (18) extending transversely between the side plates (14, 16); and,
a pair of segmented jaw arms (12) each including a main body portion (54) and a plurality of sets (162, 164, 166, 202, 204, 206) of front body portions (52′, 52″, 52′″, 210, 212, 214) each being selectively connectable at a hinge region (50) allowing an angle of rotation (A) between respective hinged main (54) and front (52′, 52″, 52′″, 210, 212, 214) body portions, the main body portions of said pair of segmented jaw arms being disposed between said pair of side plates (14, 16) and having pivot pin openings (24) receiving said pivot pins (18) between said side plates (14, 16) for pivotal displacement of the jaw arms (12) about corresponding parallel pivot axes (82) between opened and closed positions, each jaw arm (12) of said pair of segmented jaw arms having inner (34) and outer (32) edges laterally spaced from and extending forwardly of a first plane T connecting the pivot axes, the jaw arms (12) during use of the jaw set system being pivoted about the pivot axes (82) to displace said front body portions (52′, 52″, 52′″, 210, 212, 214) laterally toward one another from said opened position to said closed position of the jaw arms (12) for the front body portions to perform an operation on an associated workpiece therebetween.

34. The hinged jaw set system (160) according to claim 33 wherein:
a first set (162) of said front body portions (52′) defines a first recess (36′) having a first size;
a second set (164) of said front body portions (52″) defines a second recess (36″) having a second size larger than said first size;
a third set (166) of said front body portions (52′″) defines a third recess (36′″) having a third size larger than said second size; and,
said operation performed on said associated workpiece is a pressing operation using a one of said first, second and third recesses (36′, 36″, 36′″) by a selective attachment of a one of said front body portions (52′, 52″, 52′″) with said main body portion (54) at said hinge region (50).

35. The hinged jaw set system (200) according to claim 33 wherein:
a first set (204) of said front body portions (210) defines a first recess (220) having a generally flat circular surface configured to receive a round workpiece;
a second set (204) of said front body portions (212) defines an upper gripping jaw (224) and a lower gripping jaw (226) spaced apart by a gap (228) therebetween;
a third set (206) of said front body portions (214) defines a pair of opposed cutting portions (234) having a cutting edge (236) thereon; and,
said operation performed on said associated workpiece is a one of a pressing operation using the first set (202) of the front body portions (210), a gripping operation using the second set (204) of the front body portions (212), and a cutting operation using the third set (206) of the front body portions (214), by a selective attachment of a one of said front body portions (210, 212, 214) with said main body portion (54) at said hinge region (50).
